(19) United States
(12) Patent Application Publication
(10) Pub. No.: US 2006/0267377 A1
(43) Pub. Date: Nov. 30, 2006

(54) Shipping container

(76) Inventors: Burt Lusk, Deer Park, TX (US); Kevin Newkirk, Friendswood, TX (US); Glenn Wiseman, Crosby, TX (US); George Cook, Ottawa, IL (US)

Correspondence Address: John W. Chestnut;Greer, Burns & Crain, LTD., Suite 2500, 300 South Wacker, Chicago, IL, 60606, US

(21) Appl. No.: 11/136,923

(22) Filed: May 25, 2005

(51) Int. Cl. B62D 33/04

(52) U.S. Cl. 296/182.1

(57) ABSTRACT

A shipping container for powdered, pelleted, or other particulate material comprises an elongated body which is formed by top and bottom walls, front and back walls, and a pair of side walls. The back wall may be formed by a pair of doors which provide access to the interior storage enclosure of the body. One of the doors is provided with an inlet opening adjacent the top thereof for loading material into the storage enclosure. At least one of the doors is provided with an outlet opening adjacent the bottom thereof for unloading material from the storage enclosure. An inclined baffle extends from the bottom wall toward the outlet opening for guiding material toward the outlet opening when the front of the body is elevated. The outlet opening may include a flange for securing a flexible discharge conduit. In another embodiment the outlet opening and baffle are located in the front of the container. A front container mounted loading/unloading feature permits product delivery flexibility by allowing discharge through a tilted container without placing stress on the hinged doors.

### BACKGROUND OF THE INVENTION

This invention relates to shipping containers, and more particularly, to a shipping container which is particularly suitable for shipping particulate material, for example, powdered and pelleted materials.

There is a need for satisfactory shipping containers for particulate materials, including plastics and synthetic resins, chemicals, food products such as flour, coffee, and grain, and similar powdered, granular, or pelleted materials. These materials exhibit fluid-like or flowable properties, and they are desirably shipped in a manner which protects the material from contamination.

It is also desirable that the container can be used for shipping materials other than particulate material, for example, bulk products. A container which can be used only with particulate material is generally a one-way container which is returned empty to the original shipper. A container which can be used to ship product in only one direction substantially increases shipping costs compared to a container which can be used to ship product in both directions.

Previous attempts to provide shipping containers are exemplified by U.S. Pat. Nos. 4,875,811, 5,487,485, 5,911,337 and 6,837,391. The '811 patent describes a plastic bag inside of a conventional shipping container. The particulate material is loaded into the bag, and the bag is sealed. However, the bag increases the difficulty in loading and unloading the particulate material, and the bag creates disposal problems.

The '485 and '391 patents describe liners for a shipping container. The liners suffer from some of the same problems as a plastic bag and increase the costs of the shipping container.

The '337 patent describes a rigid aluminum vessel which is inserted into a shipping container. This vessel further increases costs and reduces the ability of the shipping container to be used for other purposes.

### SUMMARY OF THE INVENTION

The invention provides a shipping container which can be used to ship both particulate material and non-particulate material or bulk material. The container can therefore be used to ship particulate material, e.g., powdered plastic resin, in one direction, e.g., to a manufacturing facility which uses the plastic resin to manufacture molded plastic products. The shipping container can then be used to ship the manufactured products from the manufacturer.

The shipping container has the general shape and appearance of a conventional shipping container. Such containers are commonly 20 or 40 feet long and can be conveniently loaded on a truck, railroad car, or ship for transport. The container includes front and back walls, top and bottom walls, and opposite side walls which form a storage enclosure or compartment. The inside surface of each wall is coated with a material which is inert with respect to the particulate material, for example, an epoxy material such as epoxy paint. The particulate material is thereby protected from contamination.

The back wall of the container is formed by a pair of doors which are hingedly secured to the container. Each door may be releasably locked by a vertically extending locking bar. An inlet opening is provided in one of the doors so that particulate material can be loaded into the container. An outlet opening is provided in at least one of the doors and preferably both doors for unloading the material. Each outlet opening is positioned near the bottom of the container, and a baffle extends upwardly from the bottom wall toward the outlet opening for guiding material to the outlet opening when the front of the container is raised.

A discharge conduit extends from each outlet opening, and a valve or folded discharge tube is positioned in the discharge conduit for opening and closing the conduit. A pair of small doors are hingedly mounted on the larger door for covering the discharge conduit.

The 20 foot container may locate the baffle wall and load/unloading ports either in the hinged doors or in the front of the container. The forward or reverse location of the baffle and ports is optional on 20 foot containers due to the inherent construction of 20 foot containers. Forty foot containers have a goose neck protrusion to “lock” the container in a transport chassis while 20 foot containers do not have the goose neck. The ability to transport a 20 foot container in a forward or reverse mount position permits product delivery options.

### DESCRIPTION OF THE DRAWING

The invention will be explained in conjunction with illustrative embodiments shown in the accompanying drawing, in which:

FIG. 1 is a rear perspective view of a shipping container which is formed in accordance with the invention.

FIG. 2 is a longitudinal sectional view of the shipping container in the process of being loaded;

FIG. 3 is a view similar to FIG. 2 showing the front end of the container raised to facilitate unloading;

FIG. 4 is a side perspective view of the elevated container;

FIG. 5 is an internal view of the front end of the container;

FIG. 6 is an internal view of the back end of one embodiment of the container;

FIG. 7 is an enlarged fragmentary view of the unloading ports of the container shown in FIG. 6;

FIG. 8 is a fragmentary view of one of the unloading ports of FIG. 6 with one of the doors of the container open;

FIG. 9 is an enlarged fragmentary view of the loading port of FIG. 8;

FIG. 10 is a rear view of the container of FIG. 6;

FIG. 11 is a fragmentary view of the unloading ports on the back of the container of FIG. 10;

FIG. 12 is an enlarged fragmentary view of one of the unloading ports of FIG. 11;

FIG. 13 is a rear view of the container of FIG. 10 in the process of being unloaded;

FIG. 14 is a fragmentary perspective view of the loading port on the back of the container;

FIG. 15 is a fragmentary side view of the cover for unloading port;

FIG. 16 is a fragmentary internal view of the unloading port;

FIG. 17 illustrates a door for one of the unloading ports;

FIG. 18 is a sectional view taken along the line 18-18 of FIG. 17;

FIG. 19 is a view similar to FIG. 2 of another embodiment of a shipping container which is formed in accordance with the invention;

FIG. 20 is an end view of the shipping container of FIG. 19;

FIG. 21 is internal view of the back end of the container of FIG. 19;

FIGS. 22-26 are plan views of the baffle plates which are illustrated in FIG. 21;

FIG. 27 is an elevational view of the angle irons which form one of the outlet openings of FIG. 21;

FIG. 28 is a fragmentary perspective view of one of the end doors of FIG. 21 in an open position;

FIG. 29 is a fragmentary perspective view of the end door of FIG. 28;

FIG. 30 is a fragmentary perspective view of the other end door of FIG. 21;

FIG. 31 is a fragmentary end view of one of the outlet doors of FIG. 20;

FIG. 32 is a fragmentary sectional view illustrating a discharge tube attached to one of the outlet openings of FIG. 21;

FIG. 33 is a view similar to FIG. 32 showing the discharge tube stored behind the outlet door;

FIG. 34 is a view similar to FIG. 32 showing the outlet door opened and the discharge tube withdrawn from the outlet opening;

FIG. 35 is a view similar to FIG. 34 showing a vacuum tube attached to the discharge conduit;

FIG. 36 is an enlarged fragmentary view of one end of the discharge tube;

FIG. 37 is a perspective view of the vacuum tube of FIG. 35;

FIG. 38 is a view similar to FIG. 19 and is another embodiment of the invention except it is formed for a 20 foot shipping container, with the L-shaped baffle wall and loading/unloading ports positioned at the front of the container (as distinguished from a 40 foot container with loading/uploading ports in the rear doors);

FIG. 39 is an end view of the container of FIG. 38;

FIG. 40 is an internal view of the back end of the container of FIG. 38; and

FIG. 41 is a plan view of the baffle plates of FIG. 40.

### DESCRIPTION OF SPECIFIC EMBODIMENTS

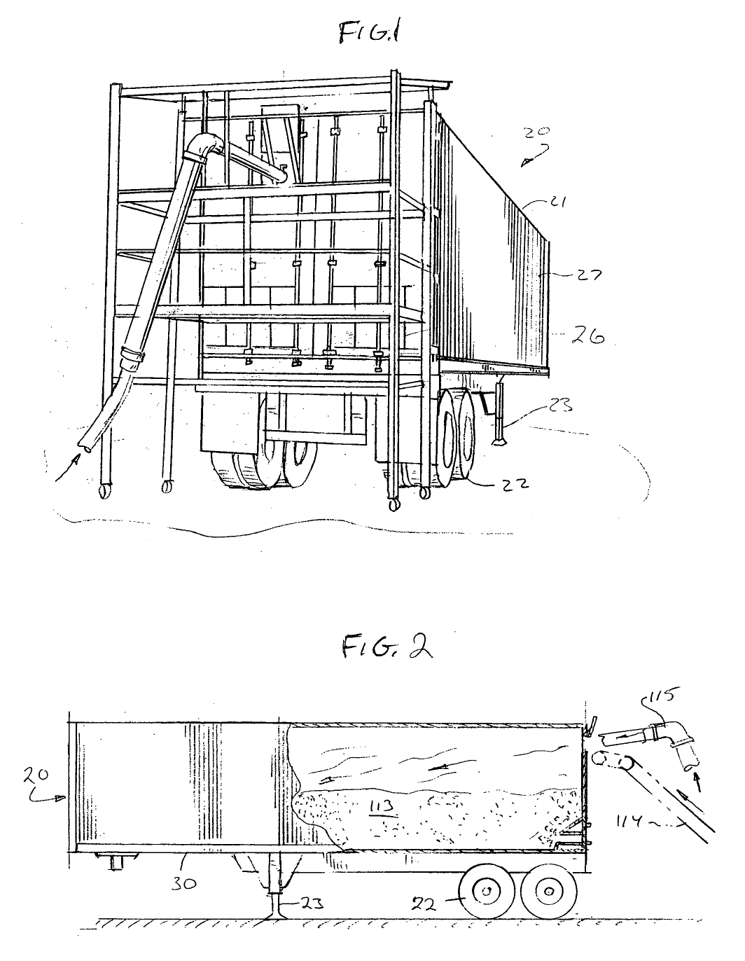

Referring to FIG. 1-5, a shipping container 20 includes an elongated container body 21 which is supported by wheels 22 at one end and a stand 23 near the other end. The particular container 20 illustrated is 40 feet long and has the configuration of a conventional shipping container. However, the container could be provided in any length, for example, 20 feet.

The container illustrated in the drawing is intended to be pulled over the road by a tractor cab and is provided with a conventional coupler for attaching the container to the cab. However, the wheels 22 and stand 23 could be omitted, and the container could be transported in other ways, for example, on a railroad car or ship.

The container body 21 is formed by front and back walls 25 and 26, opposite side walls 27 and 28, a top wall 29, and a bottom wall or chassis 30. The top and side walls may be formed from conventional corrugated sheet metal. The interior seams of the walls are advantageously welded to provide relatively smooth surfaces which do not trap granular material. The inside surfaces of the bottom and side walls, and if desired, the top wall, may be coated with an inert material, e.g., a food grade epoxy coating. Such a coating may prevent the interior surfaces from corroding and reacting with the granular material.

The back wall 26 is formed by two doors 32 and 33 which are hingedly connected to the sides of the body. Each door can be releasably locked closed by one or two conventional locking bars 34 which are rotatably mounted on the door and which extend between latches on the top and bottom walls. Each locking bar is rotatable between locking and unlocking positions by a handle 35.

### Embodiment of FIGS. 6-13

In the embodiment illustrated in FIGS. 6-13, the door 32 is provided with an outlet opening 37, and the door 33 is provided with an outlet opening 38 for unloading material from the container. If desired, only one of the doors may be provided with an outlet opening.

A generally L-shaped baffle wall 42 is secured to the inside of the door 32 at the bottom of the door, and a generally L-shaped baffle wall 43 is secured to the inside of the door 33. Referring to FIG. 8, each baffle wall includes a lower portion 44 which extends upwardly and preferably slightly rearwardly from the bottom wall 30 when the door is closed and an upper portion 45 which extends upwardly and rearwardly to the door. The upper portion is welded to the door. The baffle 43 includes an edge portion 46 which extends laterally beyond the side edge of the door 33. The edge portion 46 overlaps the welded to the door. The baffle 43 includes an edge portion 46 which extends laterally beyond the side edge of the door 33. The edge portion 46 overlaps the baffle 42 when the doors 32 and 33 are closed to provide a seal between the baffles.

The baffle 42 is provided with an opening 48 which forms part of the outlet opening 37 in the door 32, and the baffle 43 is provided with an opening 49 which forms part of the outlet opening 38 in the door 33. Two generally triangular side gusset plates 51 and 52 are welded to each baffle on opposite sides of the opening, and a bottom generally triangular gusset plate 53 is welded to each baffle below the opening. The gusset plates assist in guiding and funneling granular material to the openings in the baffles during unloading. Additional guiding and funneling is provided by an upwardly and rearwardly inclined plate 55 which is welded to the bottom wall and which mates with the bottom edges of the baffles when the doors 32 and 33 are closed.

As can be seen in FIG. 8, the lower portion 44 of each baffle is spaced forwardly from the inside surface of the associated door to provide a space or recess between the door and the baffle. Referring to FIG. 12, a box-shaped housing 57 is positioned in the recess between the door 32 and the baffle 42 and provides a compartment 58 for a valve assembly 59. The housing 57 includes a back wall 60 which is adjacent the baffle 42, top and bottom walls 61 and 62, and side walls 63 and 64 which are welded to the door 32. The door 32 is provided with a rectangular cutout to accommodate the housing 57.

A housing 66 (FIG. 11) and a valve assembly 67 are similarly positioned in the recess between the door 33 and the baffle 43.

Referring again to FIG. 12, each of the valve assemblies 59 and 67 includes a cylindrical discharge conduit 69 which extends rearwardly from an annular flange 70. The forward end of the conduit mates with the opening in the baffle. The flange is secured to the back wall 60 of the housing 57 or 66 by bolts 71.

The conduit can be opened and closed by a disc valve 73 within the conduit which is secured to a shaft 74. The shaft is rotatably mounted in the conduit and is rotatable by a handle 75 on the upper end of the shaft. A spring-loaded latch 76 on the handle releasably locks the handle and valve in the open (FIG. 11) and closed (FIG. 12) positions.

The valve compartments in the housings 57 and 66 can be covered by a pair of doors 80 and 81 which are hingedly attached to the sides of each compartment. A latch 82 on one of the doors is engage able with a catch on the other door for latching the doors closed as shown in FIG. 10.

FIGS. 17 and 18 illustrate another door 85 which can be used to cover each of the valve compartments. A single door is mounted at one side of the compartment by a hinge 86. A locking bar 87 is rotatably mounted on the door by a pair of guides 88 and 89. Right and left lock bar levers 90 and 91 are mounted on the right and left ends of the locking bar and are engage able with lever stops 92 and 93 for locking the door closed.

A handle 94 is pivotally mounted on the door by a pin 95. The handle is releasably latched by a handle lock 96. When the handle is withdrawn from the handle lock, the locking bar can be rotated by the handle to rotate the lock bar levers 90 and 91 out of engagement with lever stops 92 and 93 to permit the door to be opened. A gasket 97 (FIG. 18) within each of the lock bar guides 88 and 89 engages the locking bar.

Referring to FIG. 18, an angle iron flange 98 is secured to the sides of the compartment and surrounds the compartment. The hinge 86 is secured to the flange 98. A white rubber gasket 99 is secured to the flange for sealing engagement with the door. Another gasket 100 surrounds the compartment and is sealingly engage able with an inwardly extending edge flange 101 on the door.

Referring to FIGS. 14 and 16, one or both of the doors 32 and 33 is provided with an inlet opening 103 near the top of the door and a cover 104 which is secured to the door by hinges 105 and 106 for closing the opening. The cover 104 is latched in a closed position (FIG. 10) by a latch bar 107 which is rotatably by mounted on the door 33. The bar may be rotated by a handle 108 on the lower end of the bar. The upper end of the bar includes an L-shaped latch 109 which is positioned between the cover 104 and a rod 110 on the cover. The latch bar can be rotated to force the latch 109 against the cover to hold the cover closed as shown in FIG. 10. When the latch bar is rotated about a quarter turn, the latch 109 engages the rod 110 and holds the cover partially open as shown in FIG. 14. When the latch bar is rotated about a half turn, the latch 109 moves beyond the side of the cover, and the cover can be fully opened. FIGS. 15 and 16 illustrate the cover fully opened and propped open by a rod 111.

The inside surface of the cover 104 is advantageously coated with the same epoxy material as the inside surfaces of the container.

In the preferred embodiment the inlet opening 103 is provided near the top of one of the doors 32 and 33. However, the inlet opening could also be provided in the front wall, side walls, or top wall of the container.

### Operation

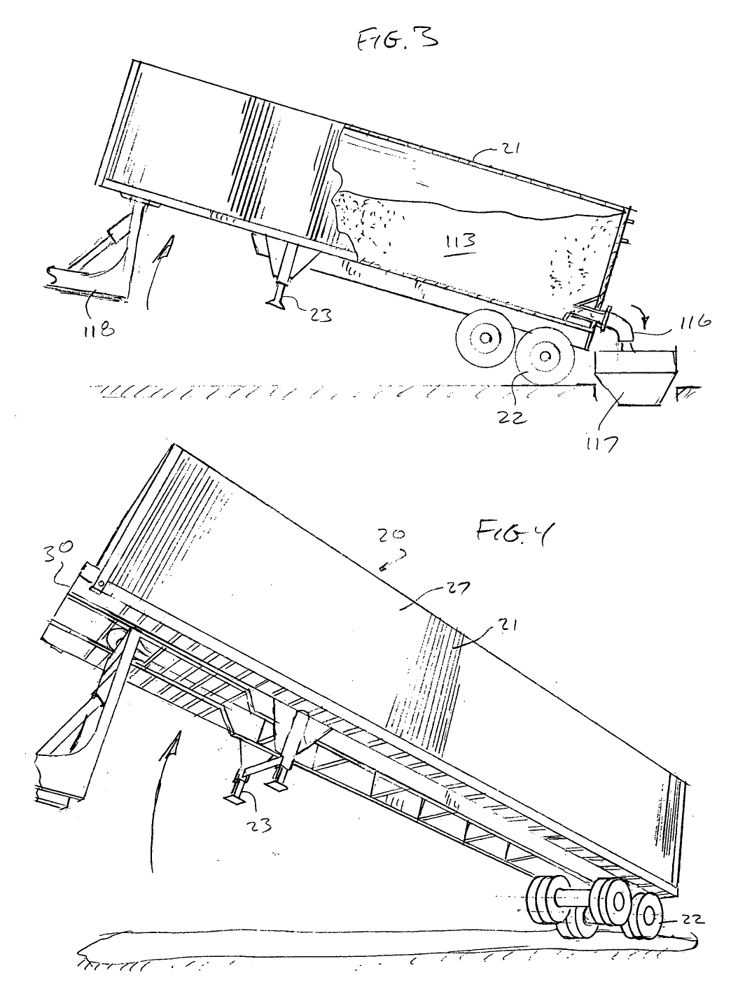

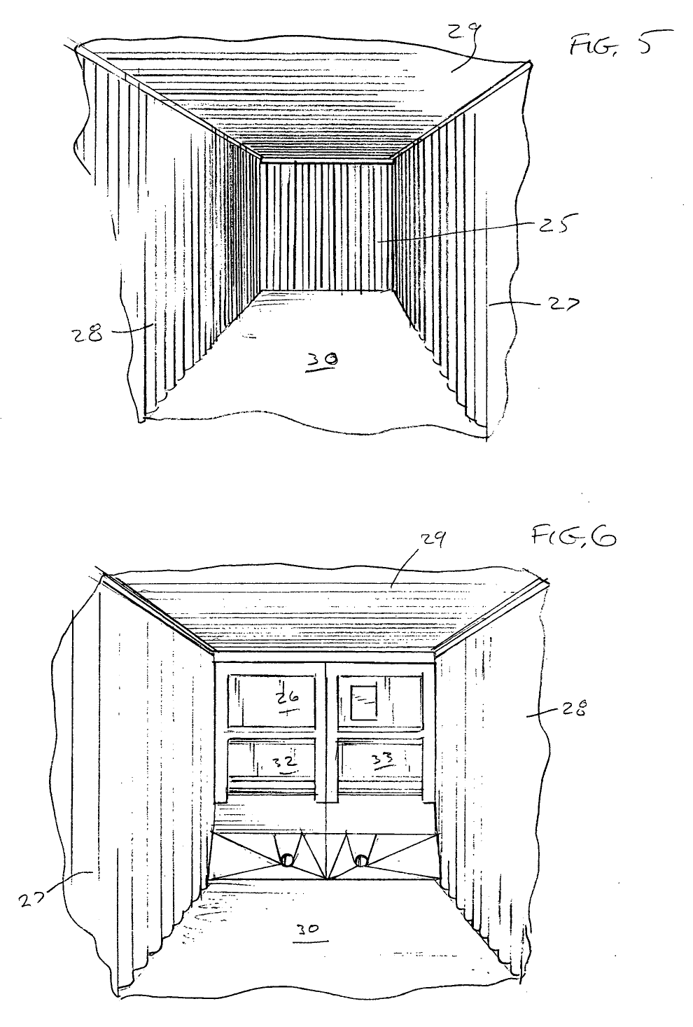

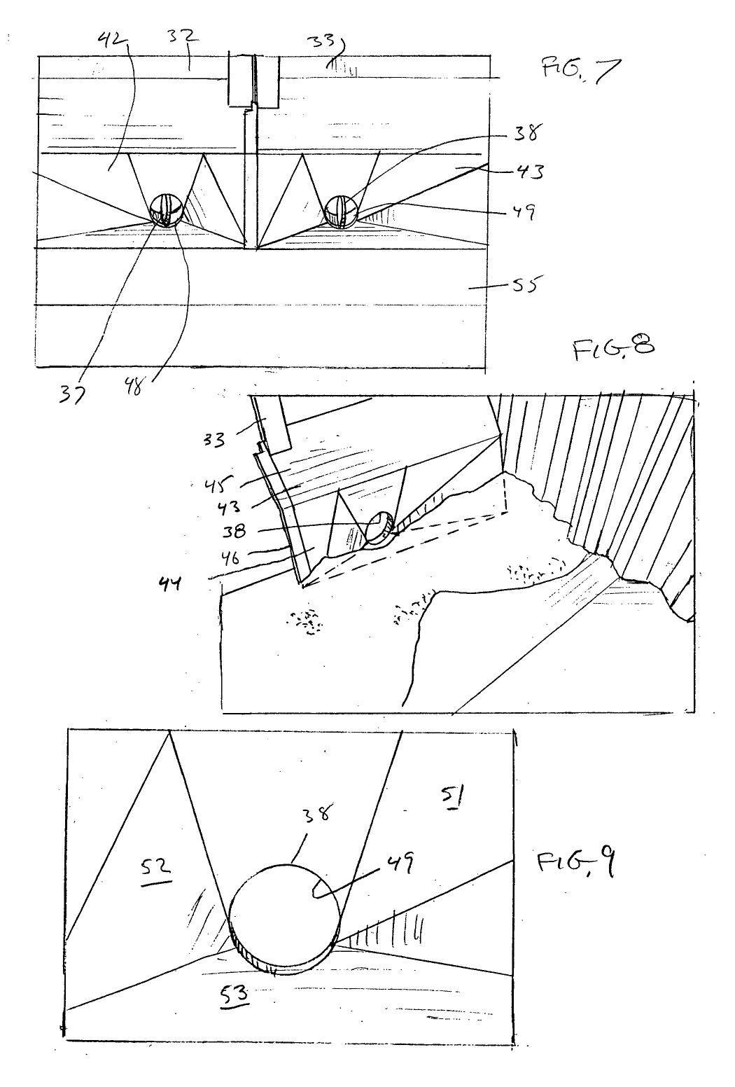

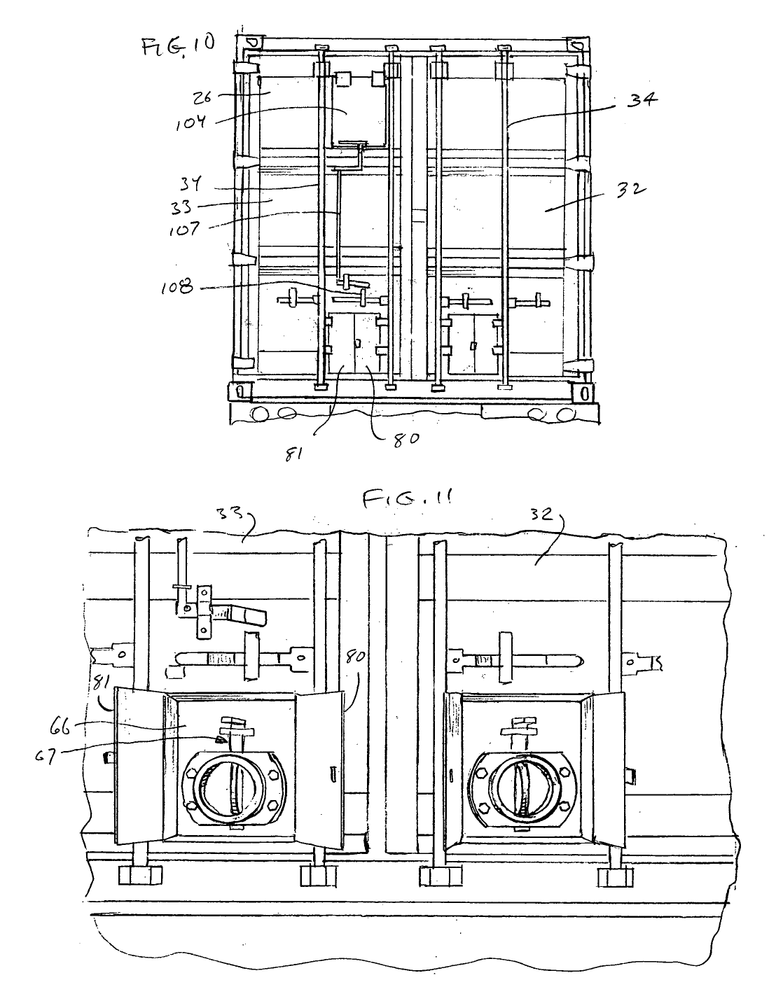

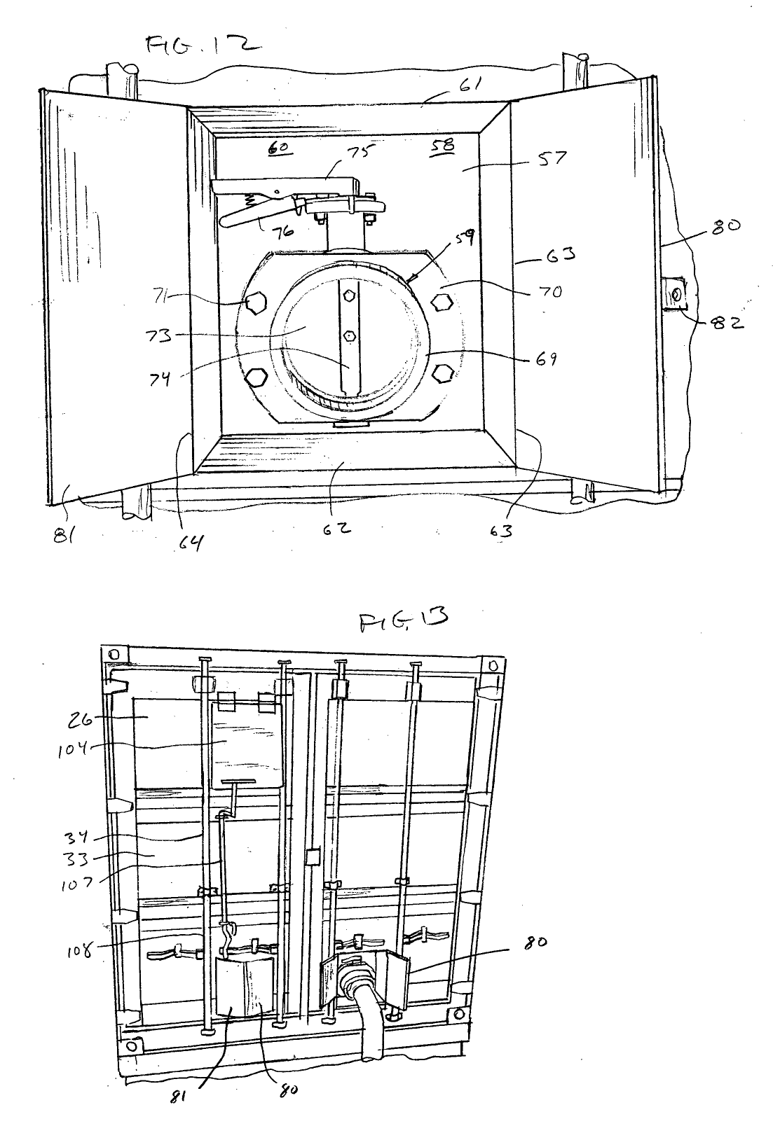

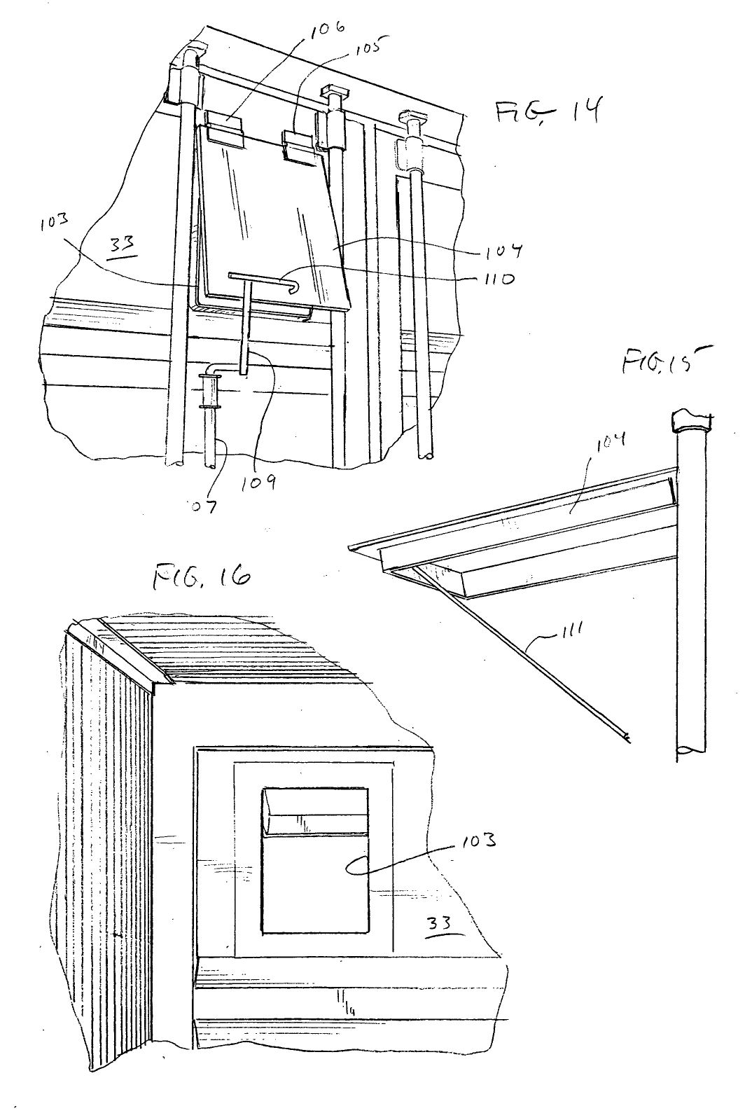

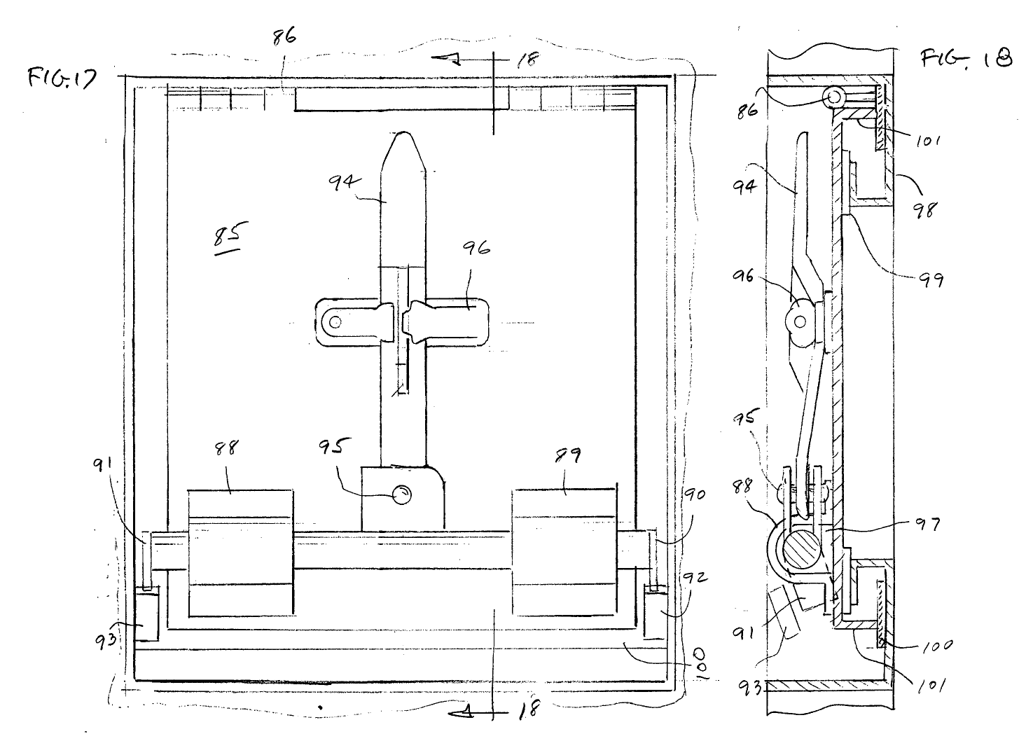

Referring to FIG. 2, the container is filled by closing the outlet openings 37 and 38, opening the inlet opening 103, and loading granular material 113 into the storage compartment of the container. In FIG. 3 a conveyor 114 conveys granular material upwardly and through the inlet opening. Alternatively, the granular material can be loaded under pneumatic pressure through a pipe or hose 115. Other methods of loading the material can also be used.

When the container is filled, the inlet opening 103 is closed, and the container is transported or shipped to its destination.

The container is unloaded by opening the doors of one or both of the outlet openings 37 and 38 and opening the valves for the outlet openings. If desired, a flexible hose 116 (FIG. 3) may be attached to each of the discharge conduits 69 for conveying the granular material to a collection hopper 117. Gravity unloading is initiated as soon as the discharge conduit is opened.

Unloading the container can be further assisted by gravity by lifting the front end of the container as shown in FIG. 3. A hydraulic lifting device 118 or similar apparatus raises the front end of the container so that the granular material flows toward the outlet openings. As the container empties, the granular material is guided and funneled to the outlet openings by the baffles 42 and 43 and by the inclined portion 55 of the bottom wall.

After the container is emptied, the container can be used as a conventional shipping container to ship bulk products, for example, molded plastic products which are made at the site to which the granular material is delivered. The container is loaded by opening the rear doors 32 and 33.

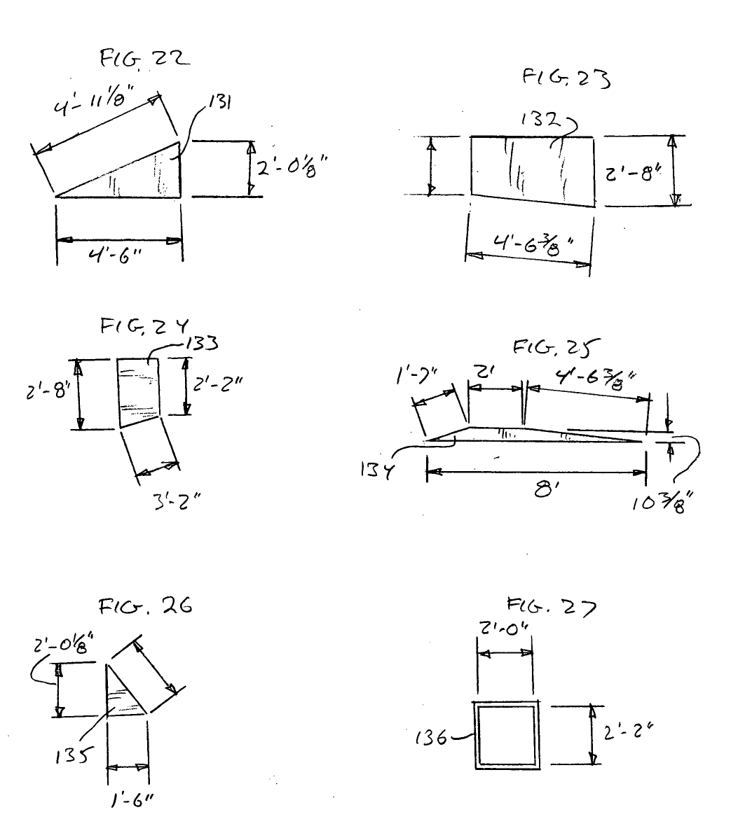

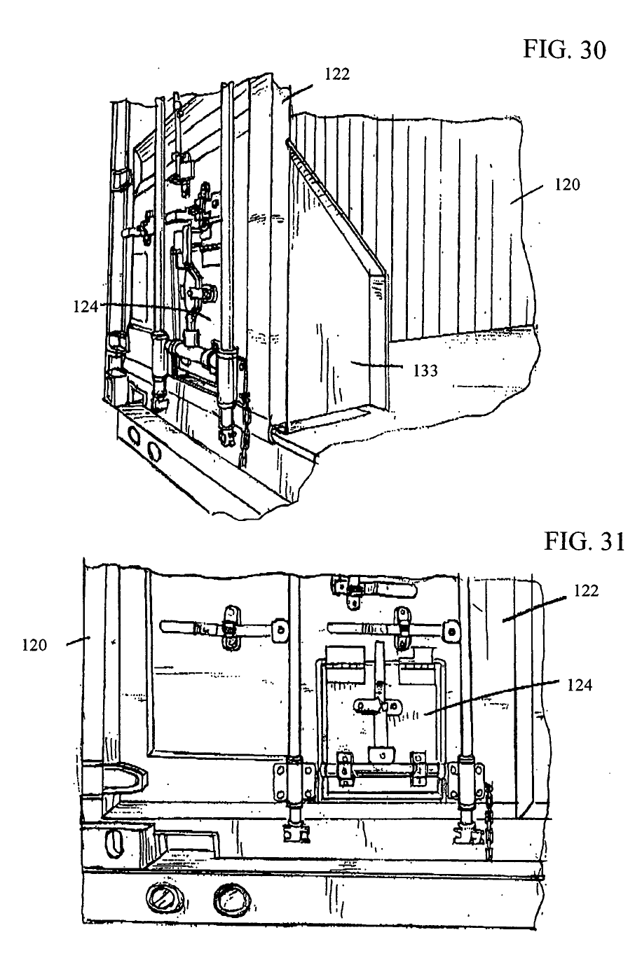

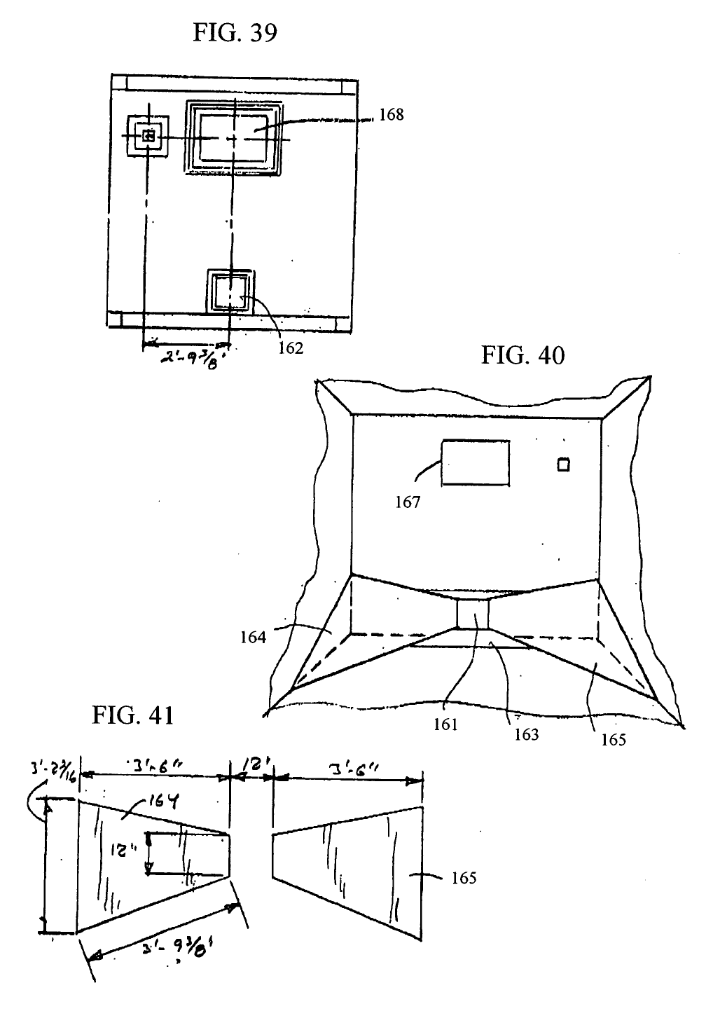

### Embodiments of FIGS. 19-41

Other embodiments of the container are illustrated in FIGS. 19-41. FIG. 19 illustrates a 20 foot trailer 120 which is similar to the trailer 20 except for the outlet openings. Referring to FIG. 20, the trailer 120 includes two rear doors 121 and 122 and two outlet doors 123 and 124 which are similar to the door 85 of FIGS. 17 and 18. Each of the doors 123 and 124 covers an outlet opening 125 and 126 (FIG. 21). An inlet opening 127 is provided in the door 122 for loading the trailer, for example, through a conduit 128.

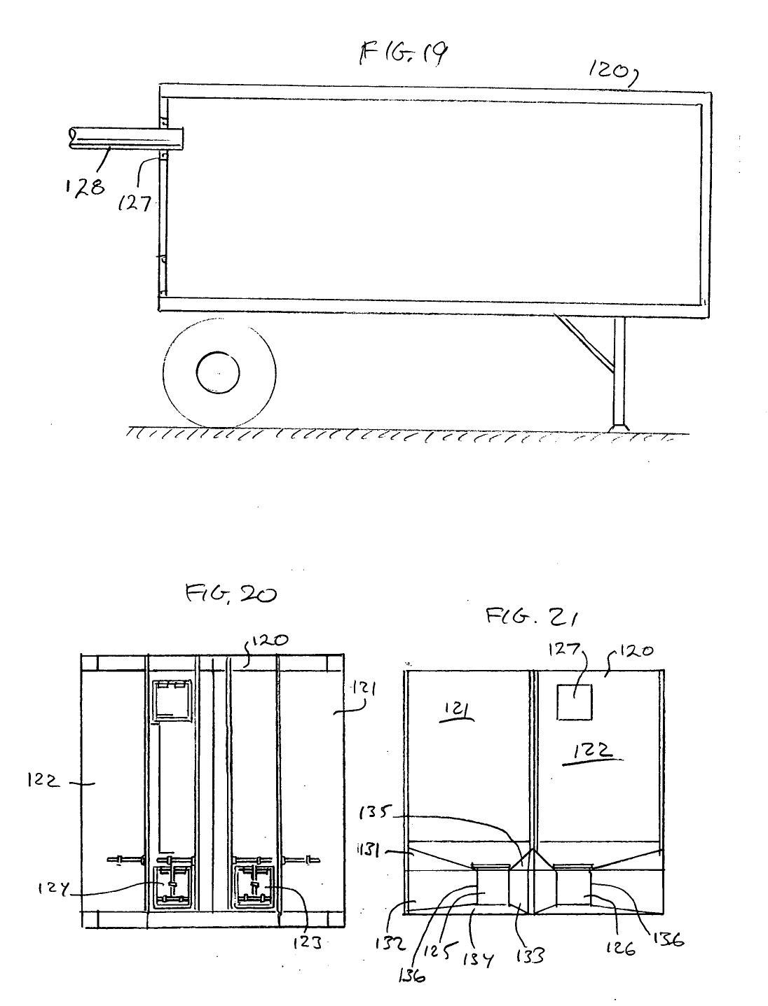

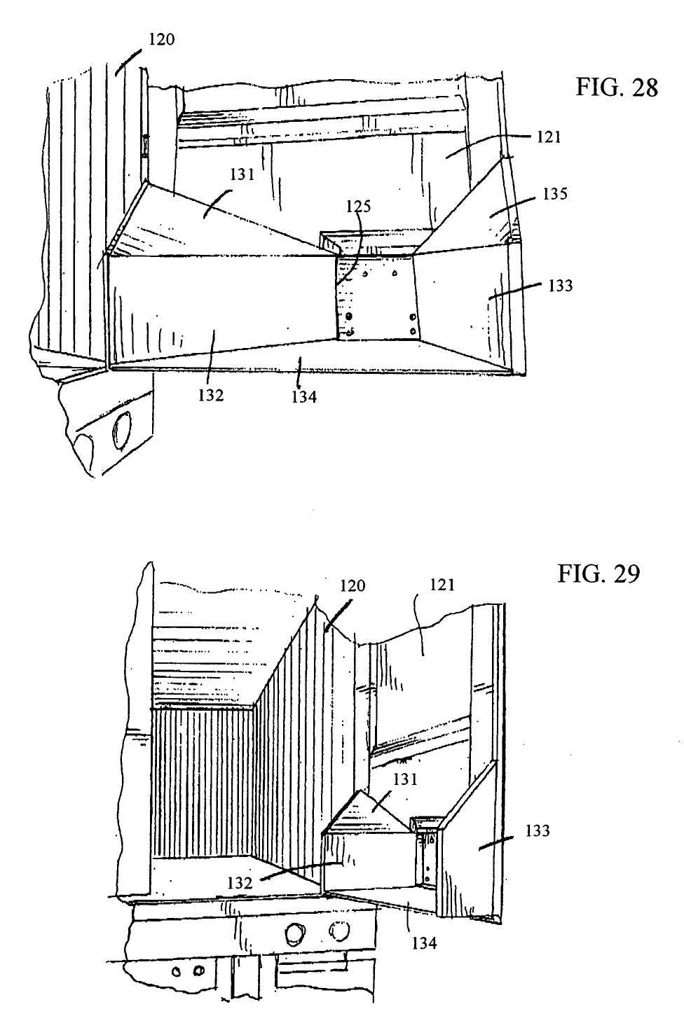

Referring to FIG. 21, each of the outlet openings 125 and 126 is rectangular and is surrounded by baffle plates 131-135 for guiding material toward the opening. The baffle plates are illustrated in FIGS. 22-26. As can be seen from FIGS. 28 and 29, the baffle plates are welded to the door 121 and 122 and extend forwardly from the outlet opening. Each baffle plate is inclined to funnel or guide material toward the outlet opening.

The baffle plate 131 extends upwardly and rearwardly from the bottom wall of the trailer. The baffle plate 132 extends rearwardly and laterally inwardly from one of the side walls of the trailer. The baffle plate 133 extends rearwardly from the center of the trailer and toward the baffle plate 132. The baffle plates 134 and 135 extend rearwardly and upwardly from the top edge of the baffle plates 132 and 133, respectively. Each of the baffle plates is advantageously formed from ½ inch steel plate Each outlet opening is defined by a rectangular border 136 which is formed by four 3 inch by 3 inch angle irons 137 (FIG. 32) which are welded to the door 121 or 122. Referring to FIG. 32, each angle iron 137 includes a rearwardly extending leg 137a and an inwardly extending leg 137b. A 1 inch by 1 inch angle iron 138 is welded to each of the inwardly extending legs 137b to form a rectangular channel 139 which surrounds the outlet opening. One of the legs 138a of each of the 1 inch angle irons forms a retaining flange 140.

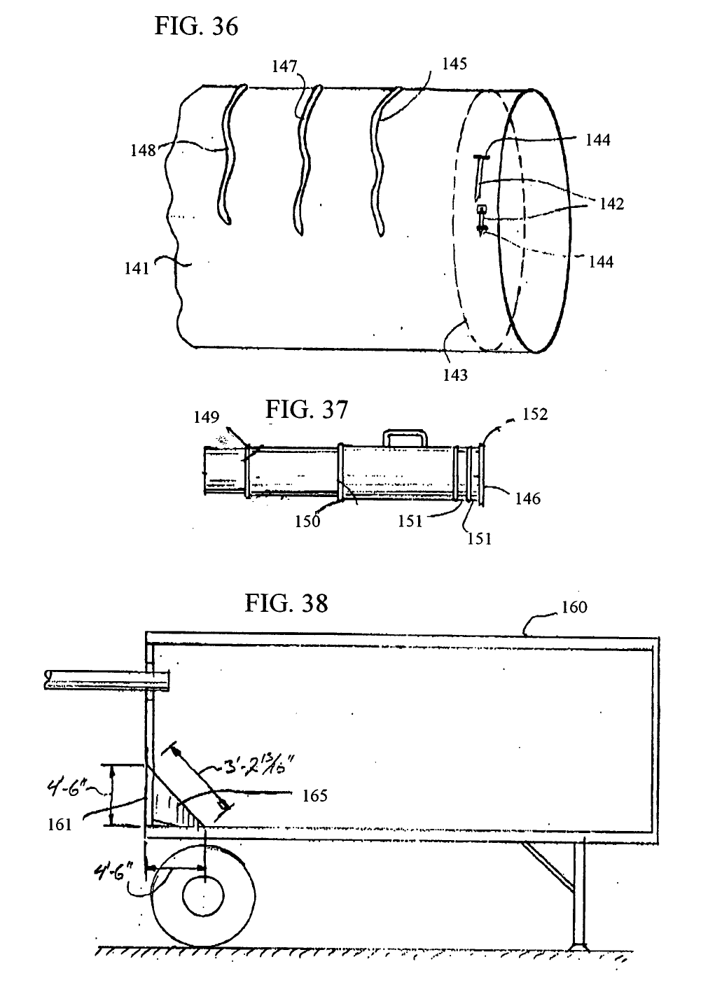

A plastic sleeve, tube, or conduit 141 is secured within the channel 139 by an industrial size zip strip 142. Referring to FIG. 36, the zip strip is secured within a hem at the forward end of the tube which is formed by stitching 143. The ends of the zip strip extend through slits 144 in the tube. The tube is secured to the outlet opening by inserting the forward end of the tube over the retaining flange 140. The zip strip is then tightened to draw the end of the tube into the channel 139. The tube is advantageously woven from plastic fibers which are inert to the granular material. Alternatively, the tube 141 can be secured to the flange by a drawstring or other means for constricting or tightening the end of the tube behind the flange.

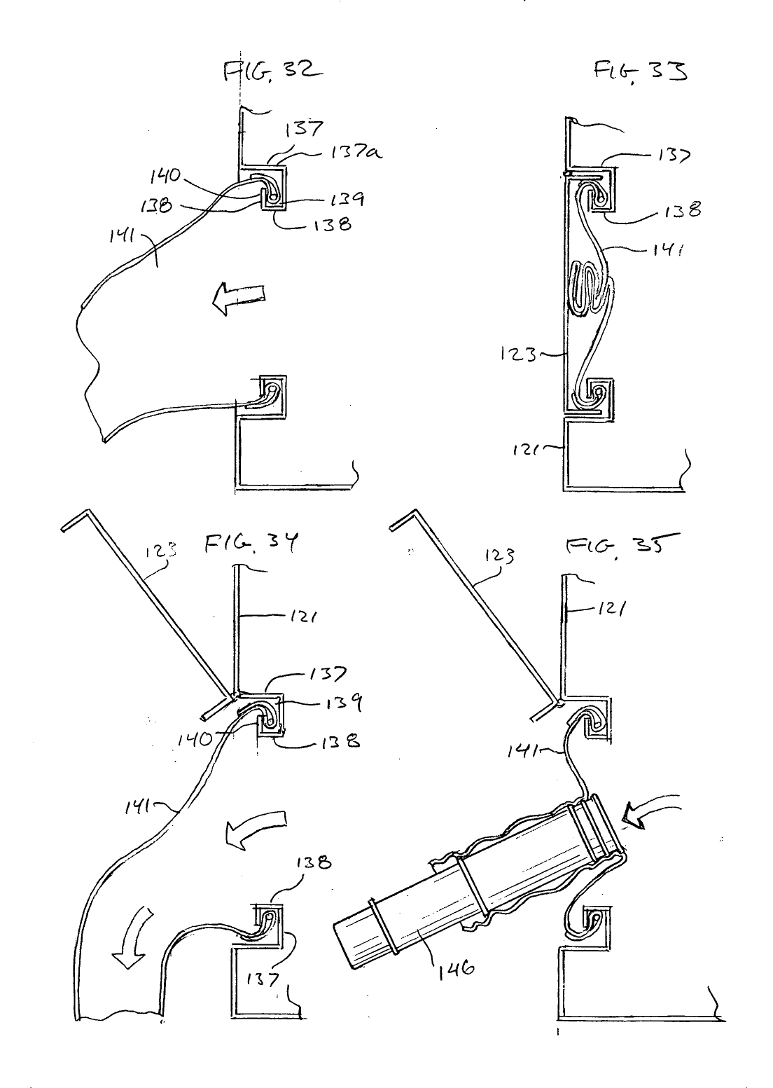

When the trailer is being transported, the tube can be tied closed by a drawstring 145 (FIG. 36) which is secured to the tube near the forward end thereof. The flexible tube 141 is then collapsed or folded and stored behind the outlet door 123 or 124 (FIG. 33). When the trailer is to be unloaded, the outlet door is opened, and the tube 141 is withdrawn and untied for gravity discharge of the material as illustrated in FIG. 34.

The trailer can also be unloaded by a pneumatic or vacuum discharge method as illustrated in FIG. 35. A solid or non-porous vacuum tube 146 is inserted through the flexible tube 141. The tube 146 is advantageously aluminum. The flexible tube is secured to the vacuum tube 146 by drawstrings 147 and 148 (FIG. 36) on the flexible tube. Referring to FIG. 37, the vacuum tube includes flanges 149 and 150 which are engageable with the drawstrings 147 and 148. The rear end of the vacuum tube is provided with grooves 151 and a flange 152 for coupling the vacuum tube to a vacuum conduit for withdrawing the contents of the trailer.

The currently preferred embodiment of the inventor uses the flexible sleeve 141 for unloading the trailer rather than the valve assemblies 59 and 67 which are illustrated in FIGS. 11 and 12.

FIGS. 38-41 illustrate a 20 foot trailer 160 which has a single outlet opening 161 in the front of the container, which is covered by an outlet door 162. A bottom baffle plate 163 extends rearwardly and upwardly from the bottom wall of the trailer for guiding material to the rectangle outlet opening 161. A pair of side baffle plates 164 and 165 cover the lower corners of the trailer and also guide material to the outlet opening. The outlet opening is formed by angle irons as described with respect to the outlet openings 125 and 126. The outlet door 162 is similar to the outlet doors 123 and 124.

A loading port or inlet opening 167 is provided in the front of the container. A hinged cover 168 closes the opening.

The 20 foot container with front design has the same structure as the rear door design except it is affixed to the front of the container. Through the use of a front mounted L-shaped baffle and load/unload portals no stress is placed on the rear hinged doors when the container is tilted for gravity discharge. In addition, standard 20 foot containers are constructed in a manner that permits a reverse mount on a wheeled chassis which permits product delivery options to customers requiring gravity unloading.

A standard 40 foot container has a “front” protrusion or goose neck which acts as a locking device when the container is mounted on a chassis. This protrusion prevents a 40 foot container from being reverse mounted on a chassis. The goose neck is not present on a 20 foot container, so a 20 foot container may be reverse mounted on the chassis for movement and delivery to a customer. The cost to modify a front mounted 20 foot container chassis is less than a 40 foot container with modifications attached to the hinged doors. Not only is a cost saving present in the front “build out” of a 20 foot container, but maintenance cost is also reduced. The front hopper is somewhat larger, which permits a greater depth, allowing a greater product flow and reduced product residue in the container. The product residue for plastic granules may be only 2 or 3 pounds.

The front loading/unloading modification can be used on with 20 foot or 40 foot containers. Also, the unloading port could be in the front of the container and the loading port in the rear of the container.

While in the foregoing specification a detailed description of specific embodiments was set forth for the purpose of illustration, it will be understood that many of the details described herein can be varied considerably by those skilled in the art without departing from the spirit and scope of the invention.

We claim:

1. A shipping container comprising an elongated body having a top wall, a bottom wall, a front wall, a back wall, and a pair of side walls which form a storage enclosure, one of the walls having an inlet opening for loading material into the body, one of the walls having an outlet opening for unloading material from the body, and a baffle extending between the bottom wall toward the outlet opening whereby material is guided by the baffle toward the outlet opening when the front of the body is elevated.

2. The container of claim 1 in which each of said walls includes an inside surface which faces said storage enclosure and which is covered with an epoxy coating.

3. The container of claim 1 in which said back wall includes a pair of doors which are hingedly mounted on said body.

4. The container of claim 3 in which said inlet opening is provided in one of said doors and said outlet opening is provided in one of said doors.

5. The container of claim 4 in which the other of said doors has a second outlet opening, and a second baffle extending between the bottom and the second outlet opening.

6. The container of claim 5 including a pair of outlet doors hingedly mounted adjacent each of the outlet openings whereby each of the outlet openings can be covered.

7. The container of claim 6 including an inlet door hingedly mounted on the back wall adjacent the inlet opening whereby the inlet opening can be covered.

8. The container of claim 7 in which the inlet opening is positioned adjacent the top wall and the outlet openings are positioned adjacent the bottom wall.

9. The container of claim 1 including a discharge conduit connected to the said wall having the outlet opening.

10. The container of claim 1 in which said outlet opening is positioned adjacent the bottom wall and said baffle includes a bottom portion which is inclined upwardly from the bottom wall toward the outlet opening and a side portion which is inclined from one of the side walls toward the outlet opening.

11. The container of claim 1 including a flange surrounding the outlet opening, and a discharge tube connected to the flange.

12. The container of claim 11 in which the discharge tube includes means for tightening the tube behind the flange.

13. The container of claim 11 including a non-porous tube connected to the discharge tube whereby the trailer can be unloaded pneumatically through the non-porous tube.

14. The container of claim 13 including means for tightening the discharge tube around the non-porous tube.
